(19) United States
(12) Patent Application Publication
(10) Pub. No.: US 2019/0005461 A1
(43) Pub. Date: Jan. 3, 2019

(54) MEETING SCHEDULER WITH FEEDBACK INTERFACE AND PREDICTED ACCEPTANCE

(71) Applicant: Microsoft Technology Licensing, LLC, Redmond, WA (US)

(72) Inventors: Shahil SONI, Seattle, WA (US); Michael J. Kumar, Seattle, WA (US)

(21) Appl. No.: 15/637,523

(22) Filed: Jun. 29, 2017

(51) Int. Cl. G06Q 10/10; G06Q 10/06

(52) U.S. Cl. CPC G06Q 10/1095; G06Q 10/063; G06Q 10/063116; G06Q 10/1093

(57) ABSTRACT

A method of scheduling a calendar meeting using a client device. The method includes receiving, via a graphical user interface of a client device, a rating for a first meeting, and storing the rating at a storage device. The first meeting is associated with a first meeting participant and a second meeting participant. The method also includes determining, with an electronic processor, a probability of acceptance by the first meeting participant for a second meeting, and displaying the probability of acceptance with a display screen of the client device. The probability of acceptance is based on the rating. The second meeting is associated with the first meeting participant and the second meeting participant.

### FIELD

Embodiments described herein relate to systems and methods for scheduling meetings via computing devices.

### SUMMARY

Meetings are electronically scheduled, accepted, and declined on a daily basis. Typically, a meeting organizer selects the meeting options such as time, place, participants, and topics based on his/her own preferences without considering the preferences of the other meeting participants. In many cases, when the meeting options are not desirable or accommodating to the other meeting participants, the meeting participants simply decline the invitation. The meeting organizer is then faced with a poorly attended meeting without any indication as to how to improve attendance.

Accordingly, embodiments described herein generate and provide sentiment information to aid in scheduling meetings based on historical meeting ratings. That is, a calendar application may collect meeting ratings from various users. The meeting ratings may specifically request rating information regarding each of the meeting parameters such as the location of the meeting, the meeting topic, the meeting leader or organizer, the meeting time, the meeting participants, and the like. When scheduling a new meeting, the calendar application then generates and displays an acceptance rate associated with the user based on the meeting parameters and based on historical meeting ratings. The acceptance rate then allows the meeting organizer to, among other things, estimate a number of attendees to the meeting, and change one or more of the meeting parameters to change the expected number of attendees to the meeting.

For example, one embodiment provides a method of scheduling a calendar meeting. The method includes receiving a rating for a first meeting and storing the rating. The first meeting associated with a first participant and a second participant. The method also includes determining a probability of acceptance by the first participant for a second meeting, and displaying the first participant and the probability of acceptance for the second meeting. The second meeting including the second participant. The probability of acceptance being determined based on the rating for the first meeting.

Another embodiment provides a system for scheduling a calendar meeting. The system includes a computing device. The computing device includes an electronic processor that is configured to receive a set of meeting parameters associated with a meeting request. The set of meeting parameters includes a first meeting participant and a second meeting participant. The electronic processor is also configured to access a meeting ratings database that includes historical meeting ratings, and filter the historical meeting ratings based on which historical meeting ratings are associated with the first meeting participant and the second meeting participant to identify filtered historical meeting ratings. Each historical meeting rating stored in the meeting ratings database is associated with meeting parameters including meeting participants. The electronic processor is also configured to determine a probability of acceptance for the meeting request based on the filtered historical meeting ratings, and transmit the probability of acceptance to be displayed.

Another embodiment provides a non-transitory, computer-readable medium storing instructions, that when executed, perform a set of functions. The set of functions include receiving a set of meeting parameters associated with a meeting request and accessing a meeting ratings database in response to receiving the set of meeting parameters. The set of meeting parameters includes a first meeting participant and a second meeting participant. The meeting ratings database stores historical meeting ratings. Each historical meeting rating is associated with meeting parameters including meeting participants. The set of functions also includes generating filtered historical meeting ratings by filtering the meeting ratings database based on historical meeting ratings that are associated with the first meeting participant and the second meeting participant, determining a probability of acceptance for the meeting request based on the filtered historical meeting ratings and the set of meeting parameters, and transmitting to a client device the probability of acceptance for display at the client device.

### BRIEF DESCRIPTION OF THE DRAWINGS

FIG. 1 is a block diagram of a scheduling system according to one embodiment.

FIG. 2 is a flowchart illustrating a method of scheduling a calendar meeting via a client device of the system of FIG. 1.

FIG. 3 illustrates an exemplary interface for receiving meeting ratings.

FIG. 4 is a flowchart illustrating an alternative method of scheduling a calendar meeting via the client device of the system of FIG. 1.

FIG. 5 illustrates an exemplary interface of a generated meeting request.

FIG. 6 illustrates an exemplary interface of a received meeting request.

FIG. 7 is a flowchart illustrating a method of determining a probability of acceptance.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, meeting requests are typically generated by a user with no indication of the preferences of the other meeting participants or whether the requested participants will accept. If the meeting options are not accommodating to the other meeting participants, the meeting request is declined, but no feedback is provided to the organizer to increase future meeting attendance. Additionally, when a meeting request is received by a user, the user may have difficulty deciding whether to attend the meeting.

To address these and other problems and to enhance the user's experience with calendar applications, embodiments described herein provide systems and methods for providing an expected or predicted probability of acceptance for specific meeting requests. In these embodiments, client devices communicate with a server to generate and display an expected probability of acceptance when a meeting request is created, received, or both. The expected probability of acceptance is then updated as the meeting parameters (e.g., meeting location, meeting time, meeting topic, participants, and the like) are changed. Such system allows the meeting organizer to change the meeting parameters to increase the likelihood that the meeting participants will accept the meeting request.

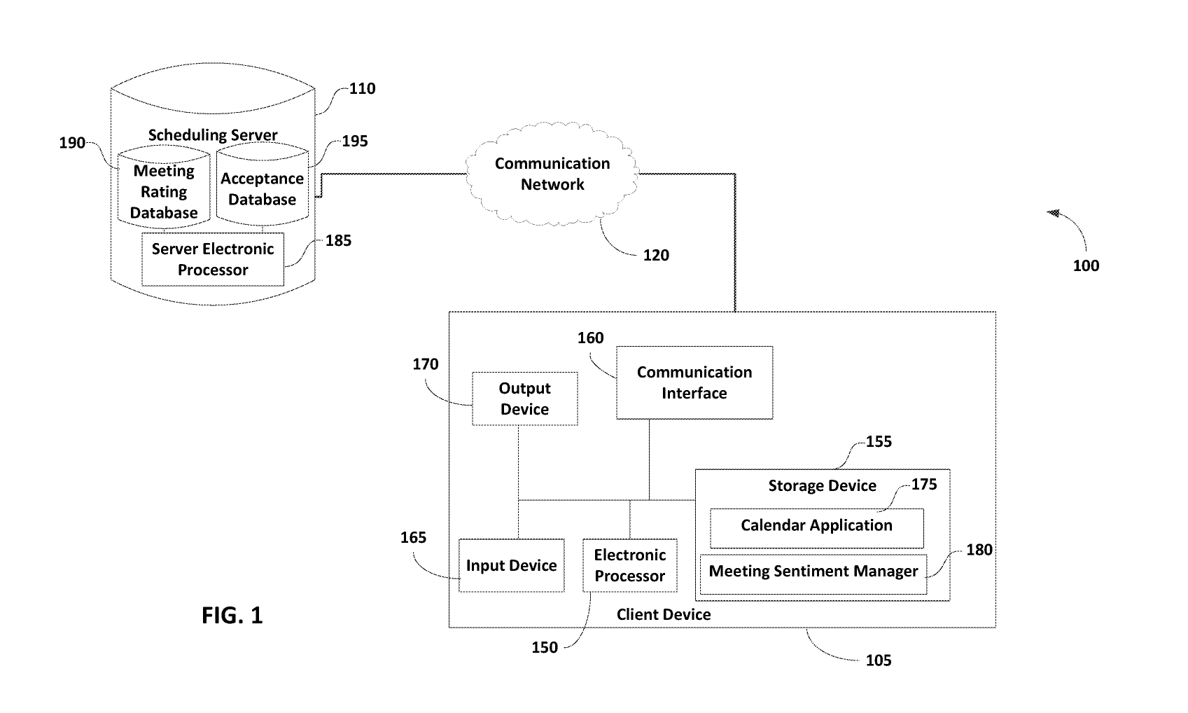

For example, FIG. 1 illustrates a system 100 for scheduling calendar meetings. The system 100 facilitates scheduling meetings among various participants and to obtain feedback regarding different meeting requests. In particular, the system 100 provides feedback to a user associated with a client device 105 to generate meeting requests with higher probability of acceptance from the other meeting participants. As shown in FIG. 1, the client device 105 communicates with a scheduling server 110 over a communication network 120. It should be understood that in some embodiments, the system 100 may include fewer or additional components in various configurations. For example, while a single client device 105 is shown in FIG. 1, more client devices 105 may be included in the system 100, and in fact, may typically be part of the system 100. Also, in some embodiments, the scheduling server 110 may be implemented by multiple servers in a distributed or cloud-based fashion. The communication network 120 may be a wired network or a wireless network and may be implemented using a wide area network, such as the Internet, a local area network, such as Wi-Fi, or combinations or derivatives thereof. In some embodiments, the communication network 120 provides a dedicated connection between the client device 105 and the scheduling server 110.

Each client device 105 may be a computing device such as, for example, a laptop computer, desktop computer, tablet computer, smart phone, smart watch, and the like. As shown in FIG. 1, each client device 105 may include an electronic processor 150 (for example, a microprocessor, application-specific integrated circuit (ASIC), or another suitable electronic device), a storage device 155 (for example, a non-transitory, computer-readable storage medium), and a communication interface 160, such as a transceiver for communicating over the communication network 120, other communication networks, or a combination thereof.

As illustrated in FIG. 1, the client device 105 also includes an input device 165 and an output device 170. In other embodiments, the client device 105 may include multiple input devices 165 and output devices 170. The input device 165 receives input from a user of the client device 105. The input device 165 may include, for example, a keyboard, a pointer device, a touchscreen, a touchpad, and the like. Analogously, the output device 170 provides output to the user of the client device 105 and may include a display device, a touchscreen, a speaker, a vibration motor, and the like. In some embodiments, the client device 105 may include a single device that operates as both an input device and an output device, such as a touchscreen. It should be understood that the client device 105 may include additional components than those illustrated in FIG. 1 in various configurations and may perform additional functionality than the functionality described in the present application.

The electronic processor 150, the storage device 155, the communication interface 160, the input device 165, and the output device 170 communicate over one or more wired communication lines or buses or wirelessly. The storage device 155 stores software (instructions) and data. For example, as illustrated in FIG. 1, the storage device 155 stores a calendar application 175 and a meeting sentiment manager 180. In some embodiments, the client device 105 may include more than one storage device and the calendar application 175 and the meeting sentiment manager 180 may be stored in separate storage devices. Additionally, although a single software application 175 is illustrated in FIG. 1, it should be understood that the storage device 155 may include multiple software applications. The storage device 155 may also store data such as, for example, personal data related to the user of the client device 105, and/or data related to scheduled meetings.

The electronic processor 150 included in the client device 105 is configured to retrieve software from the storage device 155 and execute, among other things, the software. As described in more detail below, the electronic processor 150 is configured to execute the calendar application 175 to, for example, generate and reply to various meeting requests. Each meeting request is associated with a set of meeting parameters. The meeting parameters include, for example, meeting participants (e.g., the participants to which the meeting request is sent), a meeting location (e.g., a geographic location and/or a relative location such as, “conference room”), a meeting date, a meeting time (e.g., a start time and an end time to the meeting), and a meeting topic (e.g., a meeting agenda including the topics or points to be discussed and/or resolved). The user can generate and reply to the meeting requests through the input devices 165 of the client device 105. In one example, when a user accepts a meeting request via the client device 105, the scheduled meeting, which includes the set of meeting parameters, is stored in the storage device 155. In other embodiments, scheduled meetings are stored as part of the calendar application 175. In yet other embodiments, scheduled meetings are transmitted to the scheduling server 110 and are stored remotely from the client device 105.

The electronic processor 150 is also configured to execute the meeting sentiment manager 180 to provide feedback to the user regarding meeting requests (e.g., meeting requests generated by the user and/or meeting requests received by the user). The feedback provided by the meeting sentiment manager may include, for example, an expected probability of acceptance associated with different meeting participants based on the meeting parameters of a meeting request, and sentiment trends for one or more meeting participants based on specific meeting parameters. The electronic processor 150 utilizes the output device 170, for example, a screen of the client device 105, to display such feedback to the user while the user is generating and/or replying to a meeting request. Accordingly, a user can generate meeting requests taking into consideration the preferences of other meeting participants, and the user can make a more informed decision regarding any received meeting requests based on sentiment trends of the user.

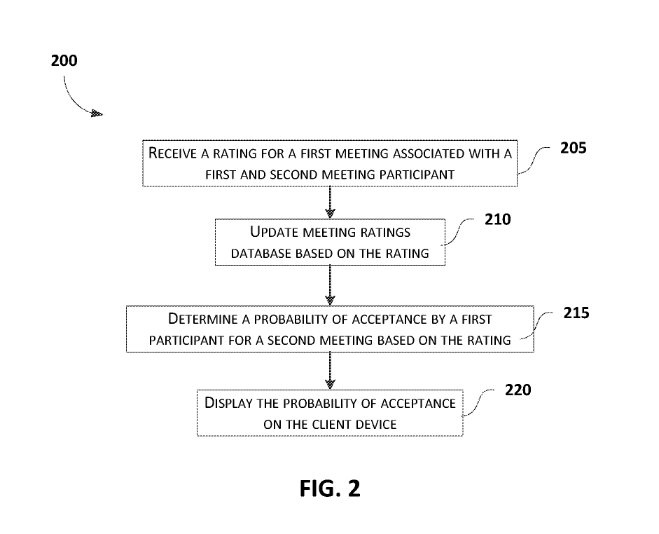

Through the communication interface 160, the client device 105 communicates with the scheduling server 110 via the communication network 120 to receive feedback for the meeting sentiment manager 180. The feedback includes, for example, a probability of acceptance of a meeting request by a meeting participant, sentiment trend associated with the user, and a particular meeting parameter (e.g., a sentiment trend for meeting held in the afternoon for a meeting participant). As shown in FIG. 1, the scheduling server 110 includes a server electronic processor 185, a meeting ratings database 190, and an acceptance database 195. The meeting ratings database 190 stores a plurality of meeting ratings from different users for different meetings. In other words, each meeting rating stored in the meeting ratings database 190 is associated with a previously held meeting and with a particular meeting participant who provided the meeting rating. For example, a first meeting rating may be associated with a first meeting participant (e.g., the meeting participant providing the meeting rating) and the corresponding meeting parameters for a first meeting including a meeting time, a meeting location, a meeting topic, and other meeting participants. A second meeting rating may be associated with a second meeting participant (e.g., a different meeting participant) and the corresponding meeting parameters for the first meeting as described above. Accordingly, the meeting ratings database 190 stores the meeting ratings provided according to the different meeting participants that provide the meeting ratings. The rating for a meeting may include a rating selection from a numerical scale (e.g., rating a meeting on a scale of one to ten), or the rating may include a rating selection from a qualitative scale ranging from poor to excellent (e.g., poor, below average, average, good, excellent). Additionally, the rating for a meeting may refer to a single rating selection (e.g., a single numerical value) for the first meeting overall. For example, a meeting attendee may select a rating of 10 overall (e.g., when a numerical scale is used). In some embodiments, the rating for a meeting may refer to a plurality of rating selections (e.g., a plurality of numerical values), where each rating selection is associated with a particular meeting parameter. For example, the meeting attendee may select a rating of 10 for the meeting location, a rating of 5 for the meeting time, a rating of 8 for the meeting topic, and a rating of 10 for the meeting participants or meeting organizer. The meeting ratings database 190 is updated when meeting participants rate new meetings such that the meeting ratings database 190 provides updated historical information on meeting ratings provided by different users (or meeting participants). FIG. 2 describes in more detail how these meeting ratings are acquired by the scheduling server 110.

The acceptance database 195 stores information regarding which meeting requests are declined and accepted by each meeting participant. In particular, the acceptance database 195 stores an acceptance indication (e.g., an indication of whether a meeting participant accepted a meeting request) associated with each meeting request that is accepted and declined. In other words, each acceptance indication is associated with the meeting parameters of the meeting request that was declined or accepted and with the meeting participant that accepted of declined the meeting request. The acceptance database 195 is updated when a new meeting request is accepted or declined. Accordingly, the acceptance database 195 provides historical information on various meeting requests that are accepted and/or declined by different meeting participants.

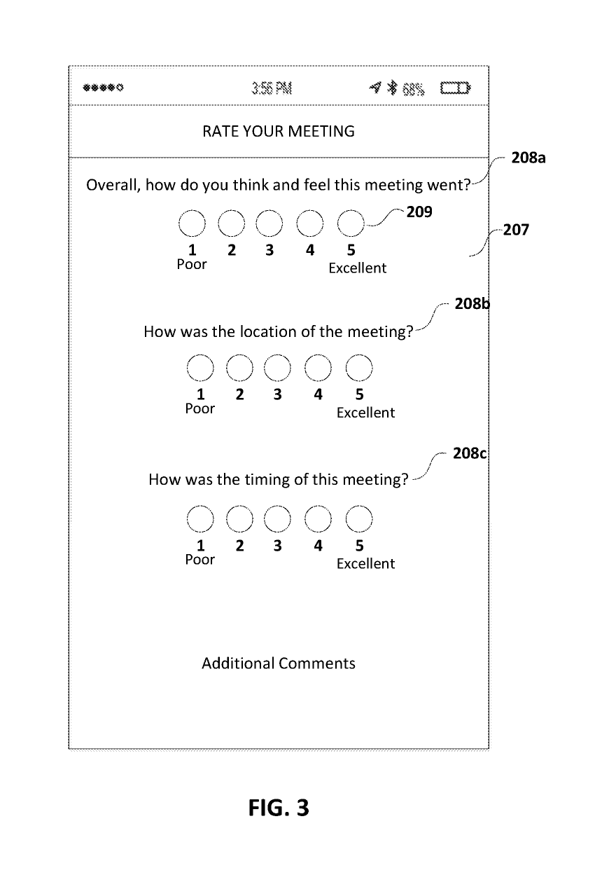

FIG. 2 is a flowchart illustrating a method 200 of scheduling a calendar meeting via the client device 105. As shown in FIG. 2, the method 200 includes receiving, via a graphical user interface of the client device 105, a rating for a first meeting (block 205). As discussed above, the first meeting is associated with a first set of meeting parameters including, for example, a first meeting participant (e.g., the meeting organizer) and a second meeting participant (e.g., a meeting attendee). FIG. 3 illustrates an exemplary interface generated by the client device 105 (e.g., the electronic processor 150) to receive the rating for the first meeting. In some embodiments, the client device 105 generates the exemplary interface for rating the first meeting after completion of the first meeting. As shown in FIG. 3, the electronic processor 150 generates a graphical user interface 207 that provides a plurality of questions 208a-c. Each question is provided with a rating scale 209 such that an appropriate rating may be selected. Some or all of the questions may be directed to determining the rating selection for a specific meeting parameter. For example, the second question requests a rating selection specific to the meeting location. The user inputs are then used to determine a rating selection for the meeting overall and/or for each meeting parameter of the meeting. The electronic processor 150 receives the rating in response to the meeting participant selecting a rating selection (e.g., via the user input device 165). As discussed above, different scales may presented as rating selections for a meeting participant.

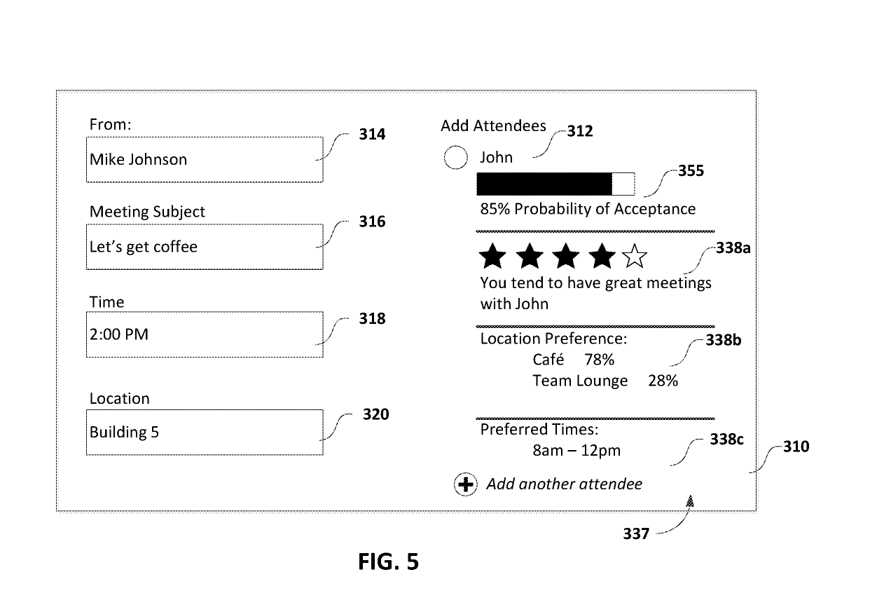

The scheduling server 110, and in particular, the server electronic processor 185, updates the meeting ratings database 190 with the rating for the first meeting (block 210). Accordingly, the meeting ratings database 190 stores the received rating for the first meeting. The server electronic processor 185 then determines a probability of acceptance by the first participant for a second meeting (block 215). In the illustrated example, the second meeting is associated with the first participant and the second participant (e.g., the first participant may be a meeting attendee while the second participant may be a meeting organizer). Because the second meeting is associated with the meeting participants also present at the first meeting, the server electronic processor 185 determines the probability of acceptance for the second meeting based on the rating for the first meeting. In response to determining the probability of acceptance, the scheduling server 110 transmits the probability of acceptance to the client device 105 as the user generates the meeting request. The client device 105 displays the probability of acceptance (block 220). Accordingly, the probability of acceptance provides feedback (e.g., by displaying the probability of acceptance) based on a similar meeting previously conducted. In some embodiments, the probability of acceptance is displayed to the meeting organizer while the meeting organizer generates a meeting request including meeting parameters as shown in, for example, FIG. 5. In other embodiments, the probability of acceptance is displayed to a meeting attendee receiving a meeting request.

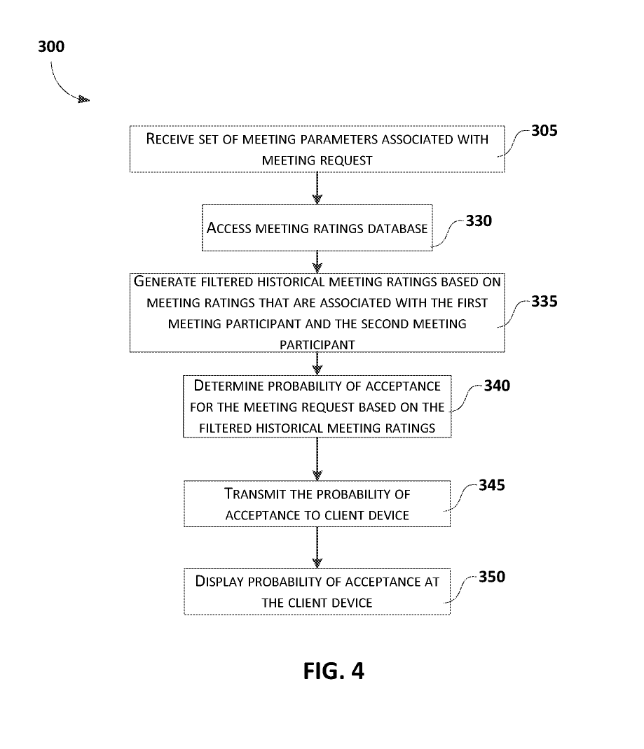

FIG. 4 illustrates another method 300 of scheduling a calendar meeting. In particular, the method 300 provides an example technique of the scheduling server 110 to generate the probability of acceptance in block 220. Notably, the system 100 may implement both the method 200 shown in FIG. 2 and the method 300 shown in FIG. 4 and described below. As shown in FIG. 4, the server electronic processor 185 receives a set of meeting parameters associated with a meeting request (block 305). The set of meeting parameters may correspond to a meeting request generated by the user of the client device 105 (e.g., when the user of the client device 105 is the meeting organizer), or the set of meeting parameters may correspond to a meeting request received by the user of the client device 105 (e.g., when the user of the client device 105 is a meeting participant). The set of meeting parameters includes, among others, a first meeting and a second meeting participant. The first meeting participant may correspond to a meeting attendee while the second meeting participant may correspond to the meeting organizer. The set of meeting parameters may include any of the meeting parameters discussed above or a combination thereof.

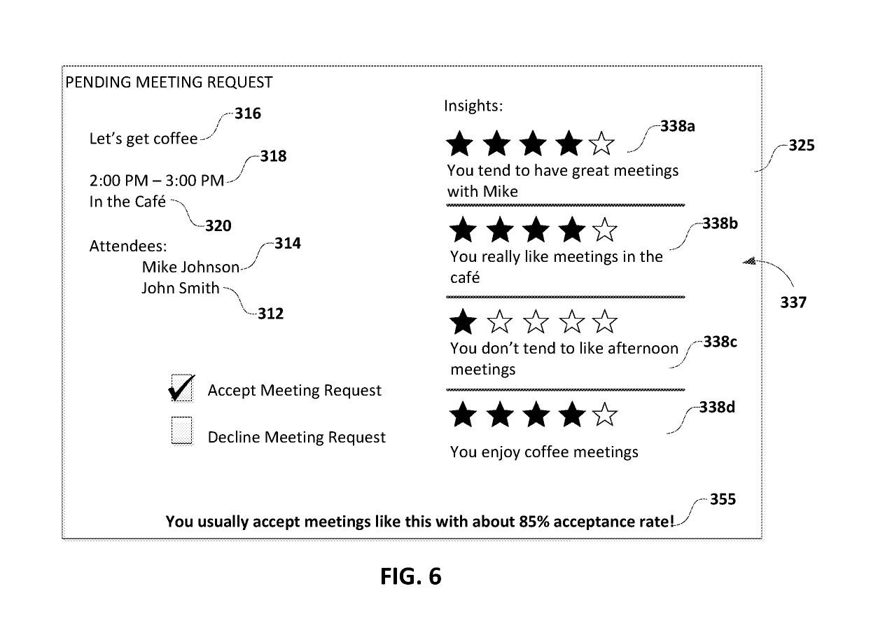

For example, FIG. 5 illustrates an exemplary interface 310 generated by the client device 105 when the user of the client device 105 corresponds to the meeting organizer. In the example of FIG. 5, the set of parameters corresponds to the meeting parameters of a generated meeting request, and includes a first meeting participant 312 (meeting attendee), a second meeting participant (meeting organizer) 314, a meeting subject 316, a meeting time 318, and a meeting location 320. In another example, FIG. 6 illustrates another exemplary interface 325 generated by the client device 105 when the user of the client device corresponds to a meeting attendee receiving a meeting request. In the example of FIG. 6, the set of parameters corresponds to the meeting parameters of a received meeting request, and includes the first meeting participant 312, the second meeting participant 314, the meeting subject 316, the meeting time 318, and the meeting location 320. In the example of FIG. 6, the received meeting request corresponds to the meeting request generated as shown in FIG. 5 and the meeting parameters, therefore, have the same values. In other examples, when the generated meeting request and the received meeting request do not correspond to the same meeting, the values for each of the meeting parameters change based on the different meetings.

In response to receiving the set of meeting parameters, the server electronic processor 185 accesses the meeting ratings database 190 (block 330). The server electronic processor 185 then generates filtered historical meeting ratings based on meeting ratings that are associated with the first meeting participant and the second meeting participant (block 335). For example, the server electronic processor 185 filters the meeting ratings stored in the meeting ratings database 190 based on the meeting ratings that are associated with the first meeting participant and the second meeting participant. In other words, meeting ratings stored in the meeting ratings database 190 that do not involve both the first and second meeting participant are filtered out and the server electronic processor 185 retrieves information regarding the meeting ratings associated with both the first meeting participant and the second meeting participant. This subset of meeting ratings that are associated with the first meeting participant and the second meeting participant may be referred to as filtered historical meeting ratings. In one embodiment, the server electronic processor 185 identifies the meeting ratings for meetings in which both the first participant and the second participant were present. In some embodiments, the server electronic processor 185 specifically filters for meeting ratings corresponding to meetings in which the first meeting participant corresponds to a meeting attendee and the second meeting participant corresponds to the meeting organizer. In one example, Mike Johnson may be the meeting organizer and invites John Smith to a meeting. The server electronic processor 185 then filters the meeting ratings in the meeting ratings database 190 based on which meeting ratings correspond to meetings in which Mike Johnson was the meeting organizer and John Smith was the meeting attendee (or one of the meeting attendees). In some embodiments, the server electronic processor 185 filters for the meeting ratings that were submitted by the first participant and that are also associated with the second meeting participant. For example, in such embodiments, the server electronic processor 185 may not analyze the meeting ratings that are associated with both the first meeting participant and the second meeting participant but were submitted by the second meeting participant.

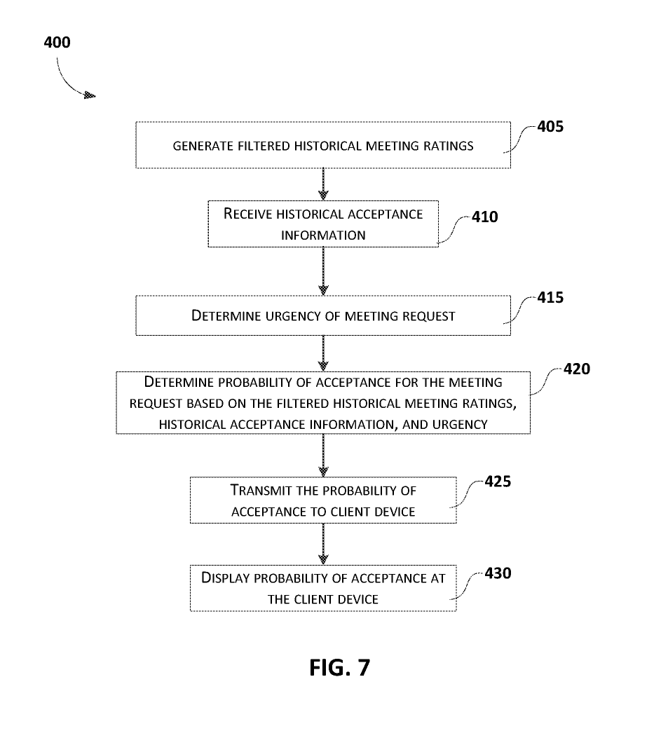

The server electronic processor 185 proceeds to determine a probability of acceptance for the meeting request by the first meeting participant based on the filtered historical meeting ratings (block 340). In particular, the server electronic processor 185 analyzes whether the filtered historical meeting ratings indicate a positive average or a positive trend (e.g., increasing ratings over time) for the meeting ratings associated with the first meeting participant and the second meeting participant (e.g., whether the filtered historical meeting ratings, on average, have ratings that are higher than a threshold). When the filtered historical meeting ratings indicate a positive trend, the server electronic processor 185 increases the probability of acceptance for the meeting request. On the other hand, when the filtered historical meeting ratings indicate a negative average or a negative trend (e.g., the filtered historical meeting ratings, on average, have ratings that are lower than a threshold, or the filtered historical meeting ratings decrease over time), the server electronic processor 185 decreases the probability of acceptance for the meeting request. As explained in further detail below with respect to FIG. 7, in some embodiments, the server electronic processor 185 receives other input information to determine the probability of acceptance.

The server electronic processor 185 then transmits the probability of acceptance to the client device 105 (e.g., via a transceiver and the communication network 120) at block 345. The client device 105 then displays the probability of acceptance on a display screen (block 350). For example, FIGS. 5 and 6 illustrate the probability of acceptance 355 for John attending the coffee meeting from Mike. Displaying the probability of acceptance on a generated meeting request such as shown in FIG. 5 allows the meeting organizer to change some of the meeting parameters to increase the probability of acceptance by the meeting participants. For example, if a meeting organizer realizes that the probability of acceptance for one or more of the meeting participants is below 50%, the meeting organizer may try to change the location and/or time of the meeting to better accommodate the meeting participants and thereby increase the probability of acceptance. As shown in FIG. 6, the client device 105 also displays the probability of acceptance 355 on a received meeting request. Displaying the probability of acceptance 355 on the received meeting request allows the receiving meeting participant to more easily determine whether the meeting request is to be accepted or declined. For example, the receiving meeting participant may see that the probability of acceptance is higher than, for example, 80% and quickly accept the meeting request without spending additional time double checking the meeting parameters before accepting the meeting request.

In some embodiments, the server electronic processor 185 filters the meeting ratings database 190 based on other meeting parameters such as, for example, meeting location. The server electronic processor 185 may then be able to extract or identify sentiment trends regarding specific meeting parameters. These sentiment trends may provide insight with respect to the probability of acceptance (e.g., may provide supporting evidence for a high or a low probability of acceptance) and may provide feedback to a meeting participant regarding a specific meeting request. Referring back to FIGS. 5 and 6, the graphical user interfaces 310, 325 generated by the client device 105 also include a sentiment portion 337. The sentiment portion 337 displays a plurality of sentiment trends. In the illustrated example of FIG. 5, the sentiment portion 337 includes a first sentiment trend 338a associated with a meeting participant (e.g., John or Mike), a second sentiment trend 338b associated with a meeting location, and a third sentiment trend 338c associated with a meeting time. These sentiment trends 338a-c may provide useful information for the meeting organizer such that when the probability of acceptance is lower than desired, the meeting organizer may be able to visually identify which meeting parameters may need to change. For example, as shown in FIG. 5, the third sentiment trend 338c associated with meeting time indicates that the meeting would be more accommodating if the meeting time changes from the afternoon to the morning. Accordingly, a change in the meeting time would likely increase the probability of acceptance for the meeting request. The sentiment portion 337 of FIG. 6 includes a fourth sentiment trend 338d associated with the meeting topic. Such sentiment trends 338a-d shown in FIG. 6 may also help a meeting attendee easily identify whether a change request is needed for the meeting request. For example, in the example of FIG. 6, the meeting participant (e.g., John) may ask the meeting organizer (e.g., Mike) to change the time of the meeting to the morning since the third sentiment trend 338c a strong preference for morning meetings. In some embodiments the sentiment portion 337 may be displayed and accessed via a separate window on the graphical user interface of the client device 105.

In some embodiments, the server electronic processor 185 receives other information used to determine the probability of acceptance. FIG. 7 illustrates a method 400 of determining the probability of acceptance. The method 400 of determining the probability of acceptance is an alternative technique to implement block 340 of FIG. 4 that uses information in addition to the filtered historical meeting ratings to determine the probability of acceptance. As shown in FIG. 7, the server electronic processor 185 generates the filtered historical meeting ratings (block 405). As discussed above with respect to block 335 of FIG. 4, the server electronic processor 185 generates the filtered historical meeting ratings by filtering the meeting ratings database 190 based on the meeting participants. The server electronic processor 185 also receives historical acceptance information from the acceptance database 195 (block 410). As described above, the acceptance database stores acceptance indications corresponding to different meeting participants for various meeting requests. In some embodiments, the server electronic processor 185 filters the historical acceptance information to obtain the acceptance indication for at least one of the meeting participants associated with a specific meeting request. For example, referring back to FIGS. 5 and 6 in which a meeting organizer Mike sends a meeting request to meeting attendee John, the server electronic processor 185 may filter the historical acceptance information based on the acceptance indications from John. In other words, the server electronic processor 185 may access the historical acceptance indications provided by the meeting attendee John instead of accessing the acceptance indications associated with different users.

In some embodiments, the server electronic processor 185 filters the historical acceptance database based on other meeting parameters such as, for example, meeting location. The server electronic processor 185 may then be able to calculate a historical rate of acceptance for each meeting parameter of the meeting request, and determine the probability of acceptance based on the various historical rates of acceptance. Referring back to the example of FIGS. 5 and 6, the meeting request may have a meeting location at the café. The server electronic processor 185 may filter the historical acceptance information based on how many meeting requests with a meeting location at the caféhave been accepted overall (by various meeting participants), or by a specific meeting participant. The historical rate of acceptance based on the specific meeting parameters of the meeting request may help provide a more accurate estimation of the probability of acceptance. In some embodiments, the server electronic processor 185 may combine the historical rates of acceptance by, for example, calculating an average historical rate of acceptance considering the meeting parameters of the meeting requests. Other methods of combining the historical rates of acceptance may also be implemented by the server electronic processor 185.

In the illustrated embodiment, the server electronic processor 185 also determines a meeting urgency of the meeting request (block 415). In some embodiments, the server electronic processor 185 determines the urgency of the meeting request based on an urgency indicator on the meeting request (e.g., an optional red flag that may be associated with the meeting request). In other embodiments, the server electronic processor 185 determines the urgency of the meeting request based on the meeting topic for the meeting request. For example, the server electronic processor 185 may determine a number of previous meetings regarding the same meeting topic. In such embodiments, the server electronic processor 185 may assign a higher urgency to the meeting request when the number of previous meetings regarding the same (or similar) meeting topic is higher than, for example, a threshold and/or an average number of previous meetings.

In some embodiments, the server electronic processor 185 determines the urgency of the meeting request by analyzing, for example, e-mail communications between the meeting participants. For example, the server electronic processor 185 may communicate with an e-mail server, or may request information from the client device 105 regarding the e-mail communication of the user. The server electronic processor 185 may then determine whether the meeting topic has been included or mentioned in the e-mail communications between the meeting participants. In one example, two users exchange several e-mails within a week regarding a project with an approaching deadline. One of the users then generates a meeting request to discuss the project. In such an example, the server electronic processor 185 may receive the meeting parameters for the generated meeting request, and specifically the meeting topic.

The server electronic processor 185 may then query an e-mail application, the client device 105, and/or an e-mail server to determine whether the meeting topic has been mentioned in e-mail communications between the two users. In some embodiments, the server electronic processor 185 may determine a frequency in which the meeting topic is mentioned in e-mail communications associated with at least one of the users. The server electronic processor 185 then determines the urgency of the meeting request based on the information received regarding the users' e-mail communications. For example, the server electronic processor 185 may assign a higher urgency to meeting requests for which the meeting topic has been discussed in e-mail communications, or may assign a higher urgency to meeting requests for which the frequency of discussion of the meeting topic in e-mail communications is above a particular threshold. Accordingly, the server electronic processor 185 is able to leverage information gleaned from other applications to more accurately determine the probability of acceptance for a particular meeting request.

The server electronic processor 185 then determines the probability of acceptance for a meeting request based on the meeting parameters of the filtered historical meeting ratings, the historical acceptance information (filtered or unfiltered), and the urgency of the meeting request (block 420). The server electronic processor 185 may assign a weight to each of these types of information when determining the probability of acceptance. In some embodiments, the weight may be static (e.g., preprogrammed and unchanging). In some embodiments, the weights may be dynamic and may change based on, for example, the robustness of the data stored in the meeting ratings database 190 and the acceptance database 195 relative to each other. In other embodiments, the server electronic processor 185 equally considers the filtered historical meeting ratings, the historical acceptance information, and the urgency of the meeting request. The server electronic processor 185 then transmits the determined probability of acceptance to the client device (block 425) and the client device 105 displays the probability of acceptance (block 430), as described above with respect to blocks 345 and 350 of FIG. 4.

Although the methods described herein (e.g., methods 200, 300, and 400) have been described as being implemented by the server electronic processor 185, in some embodiments, the electronic processor 150 of the client device 105 performs the methods 200, 300, 400 described with respect to FIGS. 2, 4, and 7. In such embodiments, the electronic processor 150 may still communicate with the scheduling server 110 to access information stored in the meeting ratings database 190 and the acceptance database 195, or the databases may be stored locally on the client device 105. The electronic processor 150 may then use the received information to determine the probability of acceptance as described above.

Accordingly, embodiments described herein provide feedback information regarding meeting requests based on historical meeting ratings information. Therefore, embodiments describe herein allow for meeting requests to be made that take into consideration the preferences of different meeting participants instead of just the meeting organizer and that provide a probability of acceptance for a meeting request.

Various features and advantages of some embodiments are set forth in the following claims.

What is claimed is:

1. A method of scheduling a calendar meeting using a client device, the method comprising:
receiving, via a graphical user interface of the client device, a rating for a first meeting, the first meeting associated with a first meeting participant and a second meeting participant;
updating, with an electronic processor, a meeting ratings database based on the rating;
determining, with the electronic processor, a probability of acceptance by the first meeting participant for a second meeting, the probability of acceptance based on the rating, and the second meeting associated with the first meeting participant and the second meeting participant; and
displaying, with a display screen of the client device, the probability of acceptance.

2. The method of claim 1, wherein determining the probability of acceptance includes determining the probability of acceptance based on historical acceptance information, the historical acceptance information including an acceptance indication for each meeting request associated with the first meeting participant, each acceptance indication being associated with a meeting parameter corresponding with each meeting request.

3. The method of claim 1, wherein determining the probability of acceptance includes determining an urgency associated with the second meeting, the urgency being based on a topic of the second meeting.

4. The method of claim 3, wherein determining the urgency includes determining whether e-mail communications associated with one selected from a group of the first meeting participant and the second meeting participant mention the topic of the second meeting.

5. The method of claim 1, further comprising displaying, with the display screen of the client device, a sentiment portion including a first sentiment trend associated with the second meeting participant.

6. The method of claim 5, further comprising displaying a second sentiment trend in the sentiment portion, the second sentiment trend associated with a meeting parameter, the meeting parameter including one selected from a group consisting of meeting location, meeting time, and meeting topic.

7. The method of claim 1, wherein receiving the rating for the first meeting includes receiving a rating based on one selected from a group consisting of a meeting location, meeting time, and meeting topic.

8. A system for scheduling a calendar meeting, the system comprising:
a computing device including an electronic processor, the electronic processor configured to:
receive a set of meeting parameters associated with a meeting request, the set of meeting parameters including a first meeting participant and a second meeting participant;
access a meeting ratings database, the meeting ratings database including historical meeting ratings, each historical meeting rating being associated with meeting parameters including meeting participants;
filter the historical meeting ratings based on which historical meeting ratings are associated with the first meeting participant and the second meeting participant to identify filtered historical meeting ratings;
determine a probability of acceptance for the meeting request based on the filtered historical meeting ratings; and
transmit the probability of acceptance to be displayed.

9. The system of claim 8, wherein the meeting parameters include one selected from a group consisting of meeting location, meeting time, and meeting topic.

10. The system of claim 8, wherein the electronic processor is configured to determine a meeting urgency based on a meeting topic.

11. The system of claim 10, wherein the electronic processor is configured to determine a frequency of the meeting topic being mentioned in e-mail communications associated with the first meeting participant, and wherein the meeting urgency is based on the frequency.

12. The system of claim 8, wherein the electronic processor is configured to:
generate a graphical user interface,
receive a rating for a first meeting via the graphical user interface after completion of the first meeting, and
update the meeting ratings database based on the rating.

13. The system of claim 8, wherein the electronic processor is configured to access an acceptance database including an acceptance indication for each meeting request, each acceptance indication associated with the meeting parameters of a corresponding meeting request, and wherein the electronic processor determines the probability of acceptance for the meeting request based on the acceptance database.

14. The system of claim 8, wherein the electronic processor is further configured to display a sentiment portion including a first sentiment trend associated with the second meeting participant, and a second sentiment trend associated with a different meeting parameter.

15. A non-transitory, computer-readable medium storing instructions, that when executed, perform a set of functions, the set of functions comprising:
receiving a set of meeting parameters associated with a meeting request, the set of meeting parameters including a first meeting participant and a second meeting participant;
accessing a meeting ratings database in response to receiving the set of meeting parameters, the meeting ratings database storing historical meeting ratings, each historical meeting rating associated with meeting parameters including meeting participants;
generating filtered historical meeting ratings by filtering the meeting ratings database based on historical meeting ratings that are associated with the first meeting participant and the second meeting participant;
determining a probability of acceptance for the meeting request based on the filtered historical meeting ratings and the set of meeting parameters;
transmitting to a client device the probability of acceptance for display at the client device.

16. The non-transitory, computer-readable medium of claim 15, wherein the set of meeting parameters include one selected from a group consisting of meeting location, meeting time, and meeting topic.

17. The non-transitory, computer-readable medium of claim 15, wherein the set of functions further comprising accessing an acceptance database, the acceptance database storing acceptance indications for previous meeting requests, each acceptance indication associated with a previous meeting request and a meeting parameter corresponding to the previous meeting request.

18. The non-transitory, computer-readable medium of claim 15, wherein the set of functions further comprising determining a meeting urgency for the meeting request, the meeting urgency based on a meeting topic.

19. The non-transitory, computer-readable medium of claim 18, wherein the set of functions further comprising determining a frequency of the meeting topic being mentioned in e-mail communications, the e-mail communications being associated with the first meeting participant, and wherein the meeting urgency is based on the frequency.

20. The non-transitory, computer-readable medium of claim 18, wherein the set of functions further comprising receiving a rating for a first meeting after completion of the first meeting, and updating the meeting ratings database based on the rating.
